(19) United States
(12) Patent Application Publication
(10) Pub. No.: US 2003/0048565 A1
(43) Pub. Date: Mar. 13, 2003

(54) Magnetic tape drive with means for preventing SAG of supply leader tape when being chucked with take-up leader tape

(75) Inventor: Kazuya Tamura, Isehara-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: MITSUMI ELECTRIC CO., LTD., Tokyo (JP)

(21) Appl. No.: 10/241,021

(22) Filed: Sep. 11, 2002

(30) Foreign Application Priority Data
Sep. 12, 2001 (JP) 276746/2001

(51) Int. Cl. G11B 15/46; G11B 15/48

(52) U.S. Cl. 360/73.04; 360/74.2

(57) ABSTRACT

In a tape drive in which a magnetic tape in the tape cassette loaded therein is driven and wound on a take-up reel in the tape drive, a ring cam is rotated by a mode motor and controls engagement of a supply reel motor with supply reel of the cassette and operation of a buckle to engage a take-up leader tape of the take-up reel with a supply leader tape of the magnetic tape of the cassette. The ring cam has first and second arc-shaped shielding plates at different angular positions on a circle around its rotation axis, while first and second optical switches are fixedly disposed to straddle the first and second shielding plates, respectively, to produce detection signals depending on angular position of the ring cam rotating. A control unit starts rotation of the mode motor when said cassette is loaded and then controls stop and rotation of the mode motor in response to the detection signals.

### BACKGROUND OF THE INVENTION

This invention relates to a magnetic tape drive such as a linear tape storage system represented by DLT (Digital Linear Tape) or LTO (Linear Tape Open) and, in particular, to such a magnetic tape drive having means for preventing a sag of a supply leader upon chucking the supply leader tape fed from a tape cassette (tape cartridge) and a take-up leader tape having one end connected to a take-up reel.

A linear tape storage system of the type has been developed as a backup for a computer system. A variety of linear tape storage systems have heretofore been proposed. For example, a digital linear tape drive as the DLT is disclosed in U.S. Pat. No. 5,862,014 or the like.

The digital linear tape drive (hereinafter may simply be called “driving device”, “tape drive”, or “drive”) is adapted to receive a tape cartridge (hereinafter may simply be called “cartridge” or may be called “cassette”) having a single reel (may be called supply tape reel or supply reel) and includes a take-up reel in the interior thereof. When the tape cartridge is loaded in the driving device, a magnetic tape is pulled out from the tape cartridge to be taken up by the take-up reel through a head guide assembly (HGA). The head guide assembly serves to guide to a magnetic head the magnetic tape (hereinafter may simply be called “tape”) pulled out from the tape cartridge. The magnetic head exchanges information between it and the tape. Typically, the head guide assembly comprises an aluminum plate having a boomerang-like shape and a plurality of large guide rollers, six in number, comprising bearings.

The head guide assembly is also called a tape guide assembly and is disclosed, for example, in U.S. Pat. No. 5,414,585. An example of the guide roller is disclosed in Japanese Unexamined Patent Publication No. 2000-100025.

Generally speaking, such a tape drive of the type described typically includes a substantially rectangular housing having a common base on which two spindle motors (reel motors) are mounted, as disclosed in U.S. Pat. No. 5,793,574. The first spindle motor has a spool (take-up reel) permanently mounted to the base and the spool is dimensioned to accept a magnetic tape streaming at a relatively high speed. The second spindle motor is adapted to receive a removable tape cartridge. The removable tape cartridge is manually or automatically inserted in the drive via a slot formed on a housing of the drive. When the tape cartridge is inserted in the slot, the cartridge is engaged with the second spindle motor. Prior to rotation of the first and the second spindle motors, the tape cartridge is connected to the permanently mounted spool by means of a mechanical buckling mechanism. A number of rollers (guide rollers) positioned between the tape cartridge and the permanent spool guide the magnetic tape as it streams at a relatively high speed back and forth between the tape cartridge and the permanently mounted spool.

The digital linear tape drive of the above-mentioned structure requires a pulling device for pulling the tape from the supply tape reel to the take-up reel. Such pulling device is disclosed, for example, in International Publication No. WO86/07471. According to the publication, take-up leader means (first tape leader) is coupled to the take-up reel. To the tape on the supply tape reel, supply tape leader means (second tape leader) is fixed. The first tape leader has a tab formed at its one end. The second tape leader has a locking hole. The tab is engaged with the locking hole. The take-up leader means (first tape leader) may be called a take-up leader tape while the supply tape leader means (second tape leader) may be called a supply leader tape.

Furthermore, a mechanism for joining the first tape leader to the second tape leader is required. Such joining mechanism is disclosed, for example, in International Publication No. WO86/07295.

Japanese Unexamined Patent Publication No. 2000-100116 discloses “Structure of Leader Tape Engaging Part” capable of locking an end of a leader tape (second tape leader) to a tape end hooking part of the tape cartridge without requiring a tab protruding on a lateral side of the leader tape.

U.S. Pat. No. 5,857,634 discloses a lock system for preventing the rotation of the take-up reel of the tape drive when the tape cartridge is not inserted in the drive.

The tape drive further comprises a tape head actuator assembly. The tape head actuator assembly is positioned between the take-up spool and the tape cartridge along a tape path defined by a plurality of rollers. In operation, the magnetic tape streams back and forth between the take-up spool and the tape cartridge, coming into close proximity to the head actuator assembly while streaming along the defined tape path. An example of the magnetic head actuator assembly is disclosed in U.S. Pat. No. 5,793,574 mentioned above.

On the other hand, as the tape cartridge to be received in the digital linear tape drive, one example is disclosed in Japanese Unexamined Patent Publication No. 2000-149491.

As described above, when the tape cartridge (cassette) is loaded in the tape drive, it is necessary for the take-up reel to pull the tape from the supply tape reel of the tape cartridge. To this end, the supply leader tape must be engaged with the take-up leader tape. Such engaging operation is called “chucking”. The chucking is carried out by the use of a buckle.

Upon the above-mentioned chucking, it is necessary to remove a sag from the supply leader tape. However, as will later be described in detail with reference to the drawing, an existing method of removing a sag from a leader tape has a problem that a reel driver is inevitably worn out when loading/ejecting are repeated. Further, malfunction may possibly be caused due to load fluctuation in the tape drive (mechanism).

### SUMMARY OF THE INVENTION

It is therefore an object of the present invention to provide a magnetic tape drive having means for preventing sag of a leader tape, which is capable of preventing a reel driver from being worn out even if loading/ejecting are repeated.

It is another object of the present invention to provide a magnetic tape drive having means for preventing sag of a leader tape, which is capable of preventing malfunction due to load fluctuation in a mechanism.

It is another object of the present invention to provide a magnetic tape drive which achieves the above-mentioned objects without increase of size of the magnetic tape drive.

According to the present invention, there is obtained a magnetic tape drive for driving a magnetic tape contained in a tape cassette loaded thereinto, the magnetic tape being wound on a supply reel within the tape cassette and having a supply leader tape at a leading end thereof. The magnetic tape drive comprises:

a take-up reel with a take-up leader tape;

a take-up reel motor for rotating the take-up reel;

a cassette-in switch for detecting the tape cassette loaded in the tape drive to produce a cassette-in signal;

a mode motor;

a ring cam having a cam rotating axis and rotated about the cam rotating axis by the mode motor, the ring cam having a first and a second arc-shaped shielding plates formed at different angular positions on a circle around the cam rotating axis;

a first and a second optical sensors fixedly disposed so as to straddle the first and the second arc-shaped shielding plates, respectively, when the ring cam is rotated, the first and second optical sensors producing first and second detection signals, respectively, depending on a rotation angular position of the ring cam;

a supply reel motor;

a reel driver having a rotary axis and rotated about the rotary axis by the supply reel motor, the reel driver operatively coupled with the ring cam to move along its rotary axis to engage with and rotate the supply reel in the tape cassette loaded;

a buckle supporting the take-up leader tape and operatively coupled with the ring cam to transfer the take-up leader tape to the supply leader tape to connect between the take-up leader tape and the supply leader tape; and

a control unit connected with the cassette switch, the first and second optical switches, the take-up reel motor, the mode motor, and the supply reel motor, the control unit controlling rotation of the take-up reel motor, the mode motor, and the supply reel motor in response to the cassette-in signal, the first detection signal, and the second detection signal.

In the magnetic tape drive, the control unit is actuated by the cassette-in signal to rotate the mode motor, then rotates the supply reel motor and the take-up reel motor and simultaneously stops rotation of the mode motor to make a temporal stop period when receiving the first detection signal after receiving the second detection signal, then again rotates the mode motor after the temporal strop period, and thereafter stops the mode motor when the second detection signal is stopped.

The reel driver and the ring cam are operatively coupled so that the reel driver being moved by rotation of the ring cam due to rotation of the mode motor to engage with the supply reel before the control unit receives the first detection signal.

In the magnetic tape drive, the buckle is operatively coupled with the ring cam so that the buckle is actuated by rotation of the ring cam to make the take-up leader tape engage with the supply leader tape before the control unit receives the first detection signal, and the buckle thereafter releases and transfers the take-up leader tape to the supply leader tape depending on the rotation of the supply reel motor and the take-up reel motor before the first detection signal stops.

Further, in the magnetic tape, the supply leader tape is pulled by the take-up leader tape to remove sag of the supply leader tape by the rotation of the supply reel motor and the take-up reel motor during the temporal stop period.

### BRIEF DESCRIPTION OF THE DRAWING

FIG. 1 is a plan view showing an end portion of an existing take-up leader tape used in a tape drive;

FIG. 2 is a plan view showing an end portion of a supply leader tape fed from a tape cartridge inserted in the tape drive;

FIG. 3 is a perspective view showing the structure of the tape drive;

FIG. 4 is a perspective view showing an encoder used in the tape drive illustrated in FIG. 3;

FIG. 5 is a perspective view showing the leader tape illustrated in FIG. 1 and a buckle to be fitted thereto;

FIG. 6A is a perspective view showing a cassette-in switch used in the tape cartridge illustrated in FIG. 3 and its surroundings;

FIGS. 6B and 6C are views for describing an operation of the cassette-in switch illustrated in FIG. 6A;

FIG. 7 is an exploded perspective view of a loading mechanism used in the tape drive illustrated in FIG. 3 as seen from a back surface (lower surface);

FIG. 8 is an exploded perspective view of a part of the tape drive including the loading mechanism illustrated in FIG. 7 as seen from a top surface (upper surface);

FIG. 9 is a sectional view of the loading mechanism illustrated in FIG. 7 in the state where a drive gear is retracted;

FIG. 10 is a sectional view of the loading mechanism illustrated in FIG. 7 in the state where the drive gear is operated;

FIG. 11 is a timing chart for describing operation of an existing mechanism for removing a sag from a leader tape;

FIGS. 12A through 12C are views showing states of a reel driver for describing a problem in the existing mechanism for removing a sag from a leader tape;

FIG. 13 is a perspective view showing an arrangement of a cam gear and optical sensors for detecting rotating angular positions of the cam gear in a sag preventing mechanism for removing a sag from a leader tape in a magnetic tape drive according to this invention;

FIG. 14 is a side view of a cam portion of the cam gear in FIG. 13;

FIG. 15 is a plan view of the cam portion of the cam gear;

FIG. 16 is a block diagram of a control system for controlling the sag preventing mechanism;

FIG. 17 is a timing chart for describing the operation the sag preventing mechanism for removing a sag from a leader tape according to one embodiment of the present invention; and

FIGS. 18A and 18B are views showing a positional relationship of a buckle and a reel driver for describing the operation of the sag preventing mechanism for removing a sag from a leader tape according to one embodiment of the present invention.

### DESCRIPTION OF THE PREFERRED EMBODIMENT

First, description will be made about an existing magnetic tape drive having a mechanism for removing sag from a leader tape, in order to facilitate an understanding of the present invention.

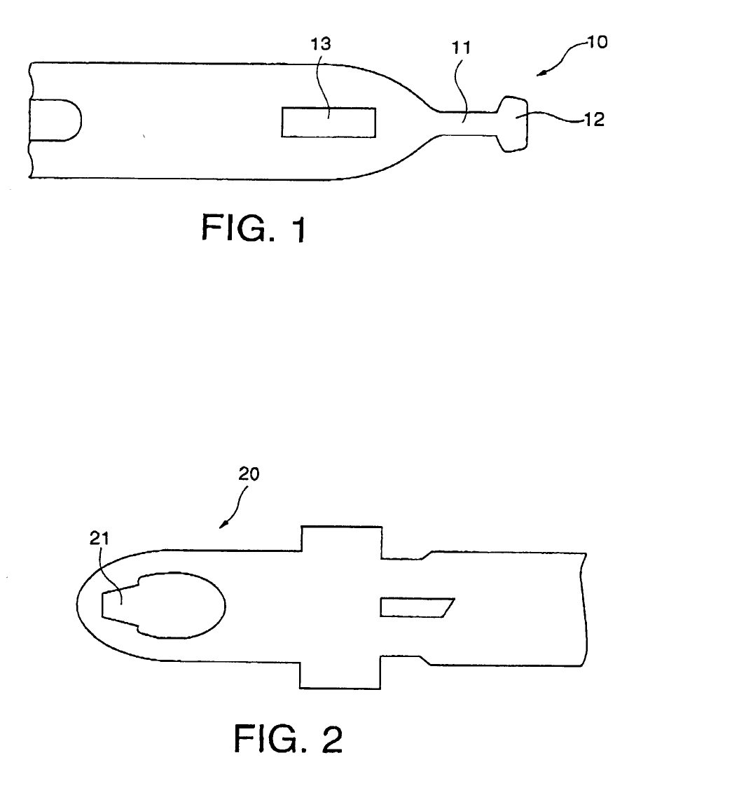

FIG. 1 shows a take-up leader tape 10 to be connected to a take-up reel. FIG. 2 shows a supply leader tape 20 to be fixed to a tape on the supply tape reel.

As illustrated in FIG. 1, the take-up leader tape 10 has one end portion formed into an enlarged tab 12 supported by a stem portion 11. Near to the enlarged tab 12, a positioning hole 13 is formed. To the positioning hole 13, a finger-like protrusion of a buckle, which will later be described, is fitted. On the other hand, as illustrated in FIG. 2, the supply leader tape 20 has a locking hole 21 formed at its one end portion. By engaging the tab 12 with the locking hole 21, the chucking is carried out.

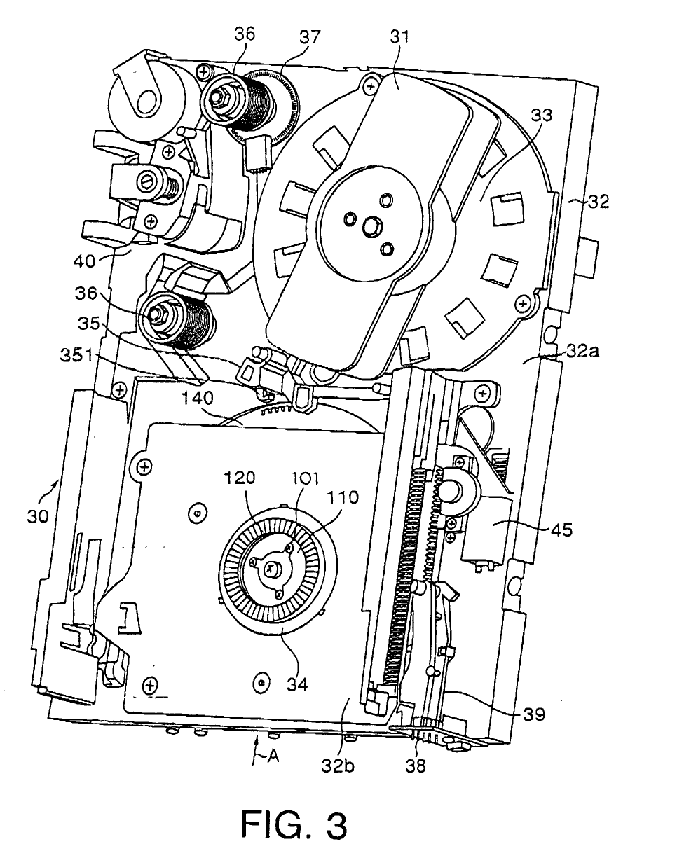

Referring to FIG. 3, description will be made of the structure of a tape drive. FIG. 3 is a perspective view of the tape drive in the state where an upper cover is removed.

The tape drive 30 is adapted to receive a tape cartridge (not shown) and includes a take-up reel 31 in the interior thereof. The take-up reel 31 may be called a spool. The tape drive 30 comprises a substantially rectangular housing (gear chassis) 32 having a common base 32a. The base 32a has two spindle motors (reel motors) 33 and 34. The first spindle motor 33 has the spool (take-up reel) 31 permanently mounted to the base 32a. The spool 31 is dimensioned to accept a magnetic tape (not shown) streaming at a relatively high speed. The first spindle motor 33 may be called a take-up reel motor. The second spindle motor 34 is adapted to receive the removable cartridge (not shown). The second spindle motor 34 may be called a supply reel motor. The removable cartridge is manually or automatically inserted in the drive 30 via a slot 32b formed on the housing 32 of the drive 30 along an inserting direction depicted by an arrow A.

When the tape cartridge is inserted in the slot 32b, the cartridge is engaged with the second spindle motor (supply reel motor) 34 by a loading mechanism which will later be described. Prior to rotation of the first and the second spindle motors 33 and 34, the tape cartridge is connected to the permanently mounted spool 31 by means of a mechanical buckle 35. A number of rollers (guide rollers) 36 positioned between the tape cartridge and the permanent spool 31 guide the magnetic tape as it streams at a relatively high speed back and forth between the tape cartridge and the permanently mounted spool 31. The housing 32 comprises a sheet metal chassis made of an iron-based magnetic material.

The tape drive 30 further comprises a magnetic tape head actuator assembly (hereinafter may simply be called “actuator assembly”) 40. The actuator assembly 40 is positioned between the take-up spool 31 and the tape cartridge along a tape path (not shown) defined by the rollers 36. In operation, the magnetic tape streams back and forth between the take-up spool 31 and the tape cartridge, coming into close proximity to the actuator assembly 40 while streaming along the defined tape path.

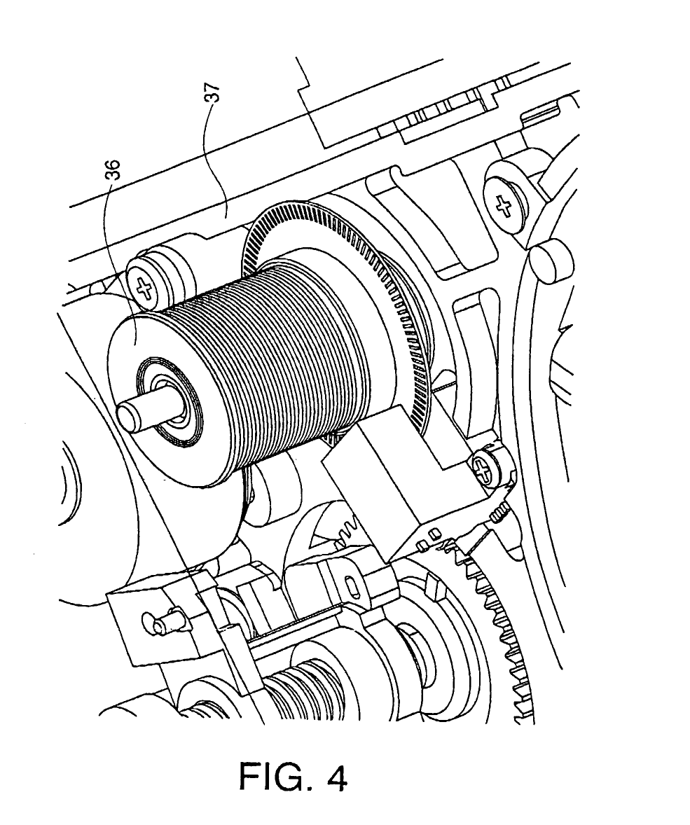

As illustrated in FIG. 4 also, one of the guide rollers 36 is provided with an encoder 37 attached thereto. By the phase of pulses produced by the encoder 37, it is possible to know whether the guide rollers 36 perform forward rotation or reverse rotation. It is noted here that the forward rotation means the rotation in a direction in which the magnetic tape is taken up by the take-up reel 31 while the reverse rotation means the rotation in a direction in which the magnetic tape is drawn out from the take-up reel 31, i.e., a direction in which the magnetic tape is rewound.

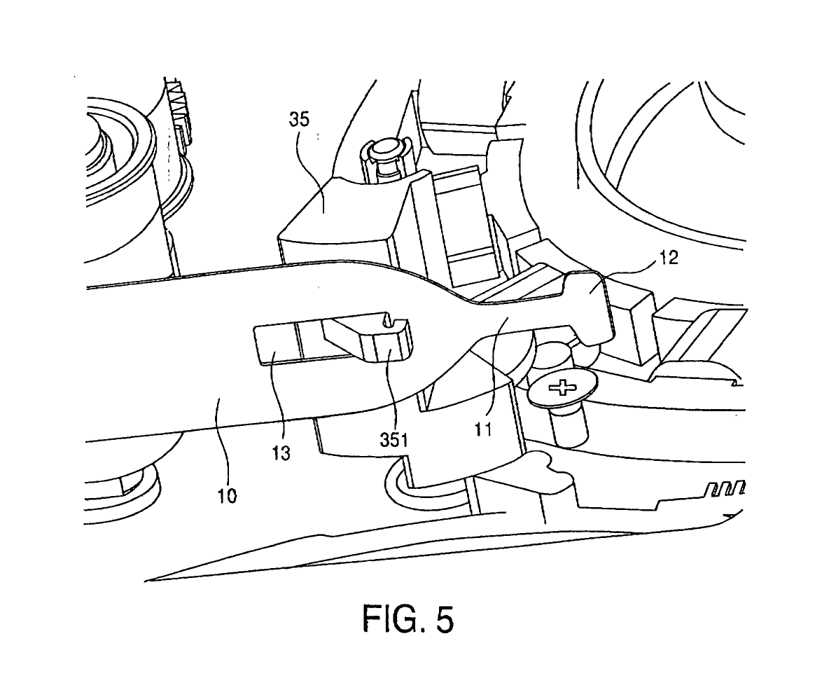

FIG. 5 is a view showing the state in which a finger-like protrusion 351 of the buckle 35 is fitted to the positioning hole 13 (FIG. 1) of the take-up leader tape 10.

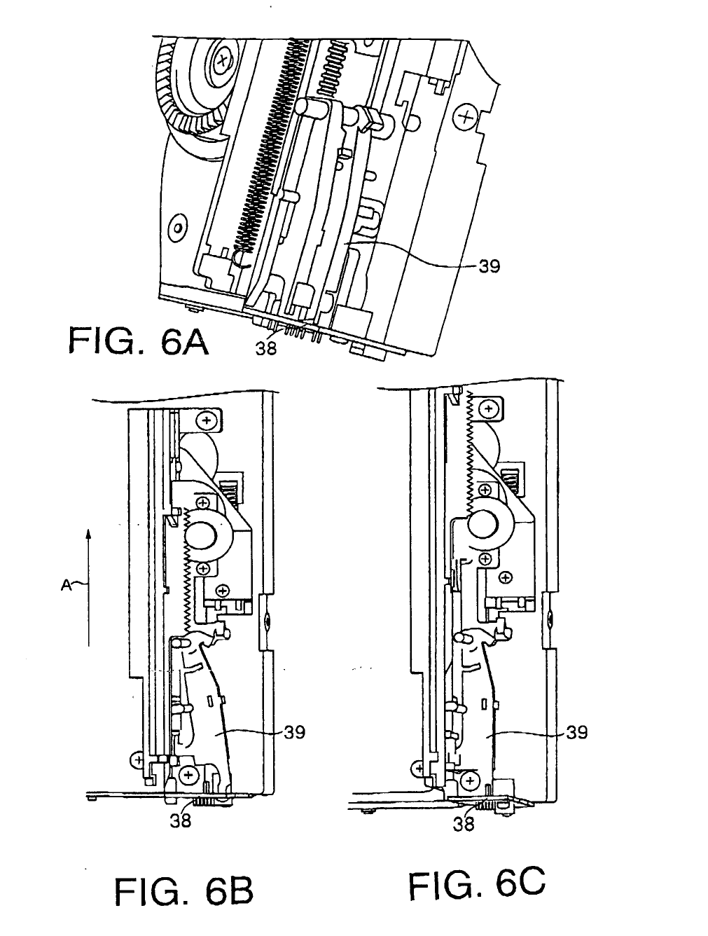

Referring to FIGS. 6A to 6C in addition to FIG. 3, the tape drive 30 comprises a cassette-in switch 38 operable in cooperation with an eject mechanism mounted to its right-hand side surface (receiver right). FIG. 6A is a perspective view showing a mounting position of the cassette-in switch 38. FIG. 6B is a view showing the state where the tape cartridge is ejected from the tape drive 30, and FIG. 6C is a view showing the state where the tape cartridge is inserted in the tape drive 30 (cassette-in state).

As illustrated in FIG. 6B, in an ejected state, a cassette-in switch lever 39 is separated from the cassette-in switch 38 and the cassette-in switch 38 is turned off. When the tape cartridge is inserted in the tape drive 30, the cassette-in switch lever 39 comes into close proximity to the cassette-in switch 38 as illustrated in FIG. 6C so that the cassette-in switch 38 is turned on.

As illustrated in FIG. 3, the tape drive 30 further comprises a mode motor 45. The mode motor 45 serves to drive a loading mechanism which will later be described, and controls up/down movement of a cartridge driver (reel driver). The mode motor 45 also controls a locked state and a released state of the buckle 35.

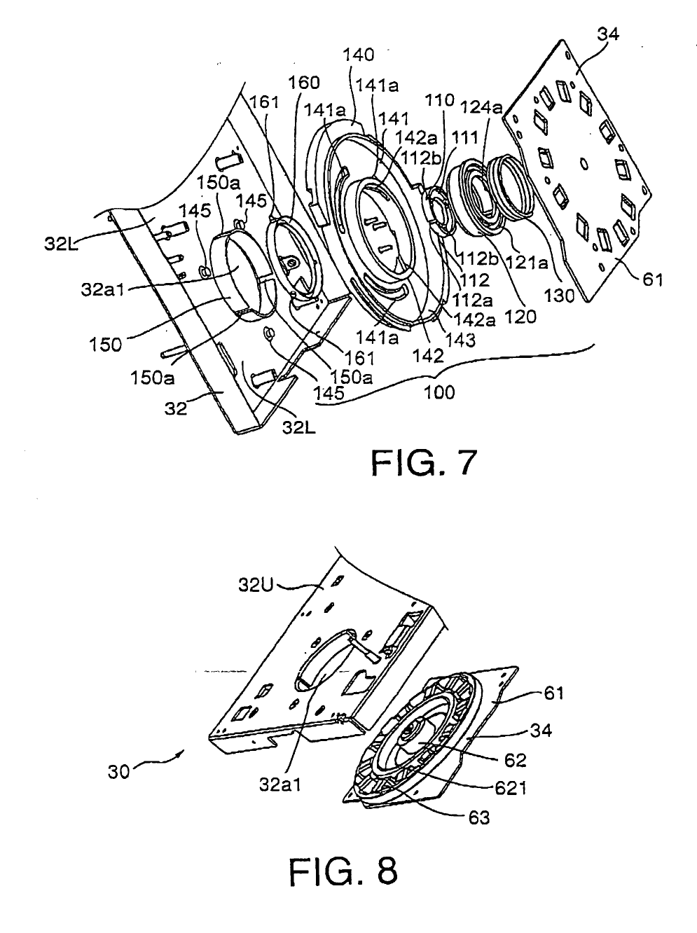

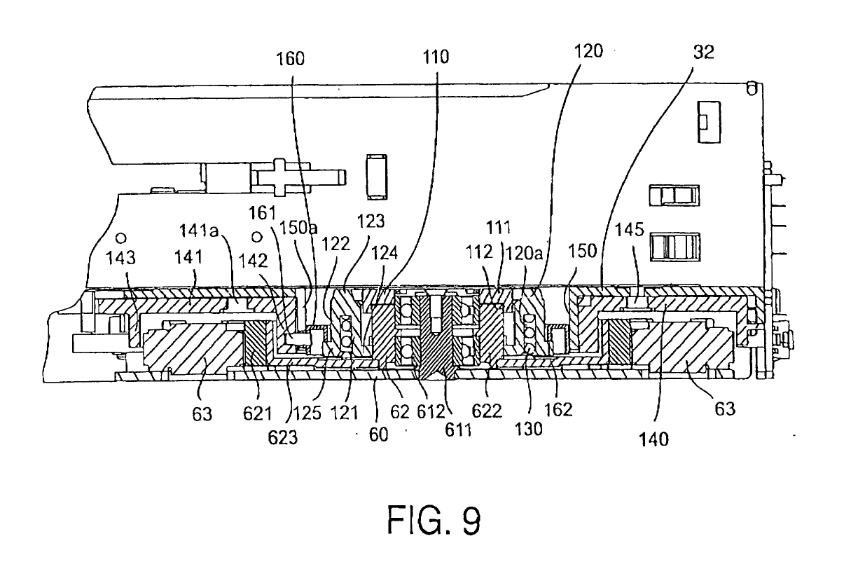

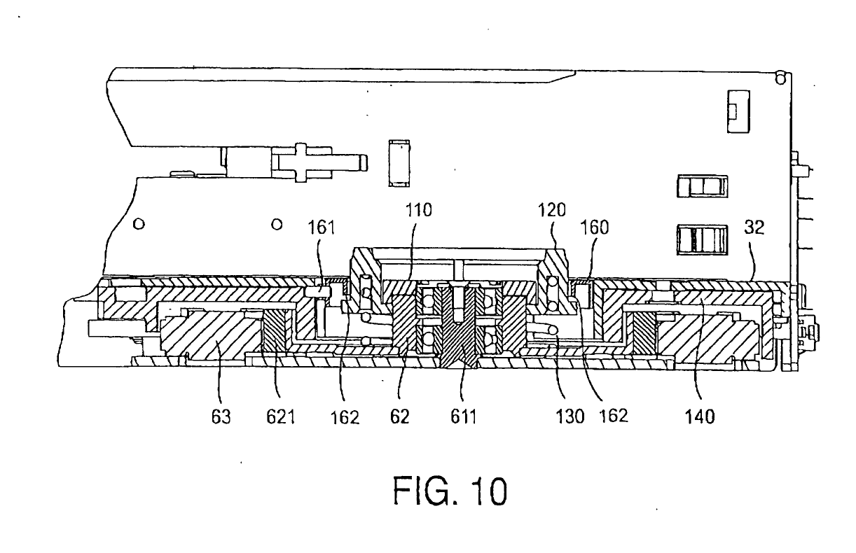

Referring to FIGS. 7 through 10, description will be made of the loading mechanism. FIG. 7 is an exploded perspective view of the loading mechanism 100 as seen from a back surface (lower surface). FIG. 8 is an exploded perspective view of the tape drive 30 including the loading mechanism (however, the loading mechanism itself is not illustrated) illustrated in FIG. 7 as seen from a top surface (upper surface). FIG. 9 is a sectional view of the loading mechanism 100 in an enlarged scale in the state where a drive gear is retracted, and FIG. 10 is a sectional view of the loading mechanism in an enlarged scale in the state where the drive gear is operated.

The tape drive 30 comprises a chassis 32 having an upper surface 32U and a lower surface 32L. The chassis 32 comprises a sheet metal chassis made of an iron-based magnetic material. The chassis 32 is provided with an opening 32a1. The opening 32a1 has a cylindrical shape formed by bending a part of the chassis 32 downward.

As illustrated in FIG. 8, the supply reel motor 34 includes a rotor 62 and a stator 63 mounted on an upper surface of a motor board 61. The rotor 62 comprises a magnet 621 exposed outward.

The supply reel motor 34 has a rotation shaft 611 fixed to the motor board 61 and vertically standing up from its approximate center. Around the rotation shaft 611, the rotor 62 is rotatably supported through a ball bearing 612. Specifically, the rotor 62 comprises a cylindrical rotation member 622 attached to the ball bearing 612, a dish-like rotation member 623 extending from a lower end of the cylindrical rotation member 622 in a direction perpendicular to an extending direction of the rotation shaft 611 and having an outer peripheral end portion perpendicularly bent upward, and a ring-shaped magnet 621 fixedly attached to an outer peripheral surface of the outer peripheral end portion of the dish-like rotation member 623.

On the other hand, the stator 63 is mounted on the motor board 61 in the vicinity of an outer peripheral side of the magnet 621 and, as illustrated in FIG. 8, comprises a plurality of radially extending stator cores and a plurality of stator coils wound around the stator cores, respectively.

The loading mechanism 100 is arranged between the supply reel motor 34 and the lower surface 32L of the chassis 32.

The loading mechanism 100 comprises a drive hub 110 fixed and mounted on an upper end of the cylindrical rotation member 622 of the rotor 62 by three screws 101 as illustrated in FIG. 3. The drive hub 110 is also called a hub driver. The drive hub (hub driver) 110 has a substantially annular shape and has an outer peripheral end bent downward. Specifically, the drive hub 110 has an annular portion 111 extending in parallel to the motor board 61 and fixed to the upper end of the cylindrical rotation member 622 and a cylindrical portion 112 perpendicularly bent downward from an outer peripheral end of the annular portion 111. The cylindrical portion 112 has an outer peripheral wall provided with three grooves 112a (although only one is illustrated in FIG. 7) formed at an interval of 120° and extending in a vertical direction (i.e., the extending direction of the rotation shaft 611). The cylindrical portion 112 has a lower end provided with three engaging holes 112b (although two of them are illustrated in FIG. 7) formed at an interval of 120° and interposed between the three grooves 112a.

A drive gear 120 is located at an outer periphery of the drive hub 110. The drive gear will be also referred to as “reel driver” or “cartridge driver”. The drive gear 120 is made of resin. The drive gear 120 may be called a reel driver or a cartridge driver. The drive gear 120 has an inner cylindrical portion 121, an outer cylindrical portion 122 spaced from the inner cylindrical portion 121 by a predetermined distance, and an annular portion 123 connecting the inner cylindrical portion 121 and the outer cylindrical portion 122 at their upper ends. Thus, the drive gear 120 has a cylindrical groove 120a defined between the inner cylindrical portion 121 and the outer cylindrical portion 122. When the drive gear 120 is moved upward as illustrated in FIG. 10, the annular portion 123 is engaged with a reel hub (spindle) of the cartridge. In the cylindrical groove 120a, a spring 130 is arranged. The spring 130 continuously urges the drive gear 120 upward. The inner cylindrical portion 121 has an inner peripheral wall provided with three rod-like protrusions 121a (only one being illustrated in FIG. 7) inserted in the three grooves 112a of the drive hub 110 and extending in the vertical direction. The drive gear 120 further comprises an inner annular flange 124 formed at a lower end of the inner cylindrical portion 121 to protrude inward and an outer annular flange 125 formed at a lower end of the outer cylindrical portion 122 to protrude outward. The inner annular flange 124 has an upper end provided with three engaging protrusions 124a (although only one is illustrated in FIG. 7) formed at positions corresponding to the three engaging holes 112b of the drive hub 110. Therefore, when the drive gear 120 is moved upward as illustrated in FIG. 10, the three engaging protrusions 124a are engaged with the three engaging grooves 112a of the drive hub 110.

In the loading mechanism 100, the drive gear 120 is retracted within the opening 32a1 as illustrated in FIG. 9 in an unoperated state and protrudes upward from the lower surface 32L of the chassis 32 as illustrated in FIG. 10 in an operated state. This means that the loading mechanism 100 comprises an elevation control mechanism (which will later be described in detail) for controlling an elevating movement of the drive gear 120. Briefly speaking, in the unoperated state of the loading mechanism 100, the elevation control mechanism carries out control so that the drive gear 120 is located downward against the urging force of the spring 130 to put the drive gear 120 in a retracted state as illustrated in FIG. 9. On the other hand, in the operated state of the loading mechanism 100, the elevation control mechanism carries out control so that the drive gear 120 is located upward as illustrated in FIG. 10 by the use of the urging force of the spring 130.

Next, description will be made in detail about the elevation control mechanism used in the loading mechanism 100.

The elevation control mechanism comprises a ring cam 140 rotatably arranged around the rotation shaft 611 so as to cover the stator 63 of the supply reel motor 34, the magnet 621 of the rotor 62, and the outer peripheral portion of the dish-like rotation member 623. The ring cam 140 may be called a cam gear. More in detail, the ring cam (cam gear) 140 comprises an annular member 141 spaced from upper surfaces of the stator 63, the magnet 621 of the rotor, and the outer peripheral end portion of the dish-like rotation member 623 by a predetermined distance so as to cover these upper surfaces, an inner-periphery cylindrical member 142 perpendicularly bent downward from an inner peripheral edge of the annular member 141 and spaced from the dish-like rotation member 623 of the rotor 62 by a predetermined distance, and an outer-periphery cylindrical member 143 perpendicularly bent downward from an outer peripheral edge of the annular member 141 and spaced from an outer peripheral edge of the stator 63 by a predetermined distance. The outer-periphery cylindrical member 143 is provided with a gear portion (not shown) formed at a part thereof to be engaged with a gear which is not illustrated. The gear which is not illustrated is engaged with the mode motor 45 (FIG. 3). Therefore, the ring cam 140 is rotatably driven by the mode motor 45. The inner-periphery cylindrical member 142 has an inner peripheral wall provided with three engaging grooves 142a (although two of them are illustrated in FIG. 7) obliquely extending from its lower end to its upper end, as illustrated in FIG. 7. The three engaging grooves 142a are located at an angular interval of 120° from one another to be rotationally or radially symmetrical with respect to the rotation shaft 611.

The annular member 141 of the ring cam 140 is provided with three arc-shaped openings 141a symmetrically formed around the rotation shaft 611 at an equiangular interval of 120°. On the other hand, the lower surface 32L of the chassis 32 is provided with three pins 145 formed at positions corresponding to the three arc-shaped openings 141a and symmetrically arranged at an equiangular interval of 120°. The three pins 145 are inserted in the three arc-shaped openings 141a corresponding thereto, respectively.

As described above, in order to form the cylindrical opening 32a1, the upper surface 32U of the chassis 32 is bent downward to constitute a cylindrical member 150. In other words, the cylindrical member 150 is formed by the use of a part of the chassis 32. The cylindrical member 150 has a function similar to that of a ring cam pivot. In detail, the cylindrical member 150 is located in the vicinity of the inner peripheral wall of the inner-periphery cylindrical member 142 of the ring cam 140. The cylindrical member 150 is provided with three slits (guide holes) 150a formed at an equiangular interval of 120° and extending long in the vertical direction parallel to the rotation shaft 611.

A drive ring 160 is disposed in frictional contact with an inner peripheral wall of the cylindrical member 150 to be movable up and down (elevatable). The drive ring 160 may be called a ring reel lift. To the drive ring (ring reel lift) 160, three rod-like pins 161 (although two of them are illustrated in FIG. 7) are attached at positions corresponding to the above-mentioned three guide holes 150a and extending outward in a radius direction (radial direction) at an equiangular interval of 120°. The three pins 161 have radially outward ends engaged with the three engaging grooves 142a formed on the inner-periphery cylindrical member 142 of the ring cam 140, respectively.

As illustrated in FIG. 9, the three pins 161 are located near lower ends of the three engaging grooves 142a when the drive gear 120 is retracted in the opening 32a1. On the other hand, as illustrated in FIG. 10, the three pins 161 are located near upper ends of the three engaging grooves 142a when the drive gear 120 is operated.

The drive ring 160 has a hook portion 162 having an L-shaped section and protruding radially inward from its upper end. The hook portion 162 is engaged with the outer annular flange 125 of the drive gear 120. Thus, it will be understood that the position of the drive gear 120 is controlled by the position of the drive ring 160.

On the other hand, the buckle 35 has an engaging portion (which will later be described) to be engaged with the cam portion of the ring cam 140. Depending upon a rotating position of the ring cam 140, the buckle 35 is put into a locked state or a released state.

The operation of the reel driver (drive gear) 120 and the buckle 35 is performed by the rotation of the cam gear (ring cam) 140. On the other hand, in the tape drive 30, when the supply leader tape 20 (FIG. 2) is chucked with the take-up leader tape 10 (FIG. 1). It is necessary to remove a sag from the supply leader tape 20, as described above. In an existing mechanism, the buckle 35 operates before the reel driver (cartridge driver, drive gear) 120 is completely lifted up, as will later be described.

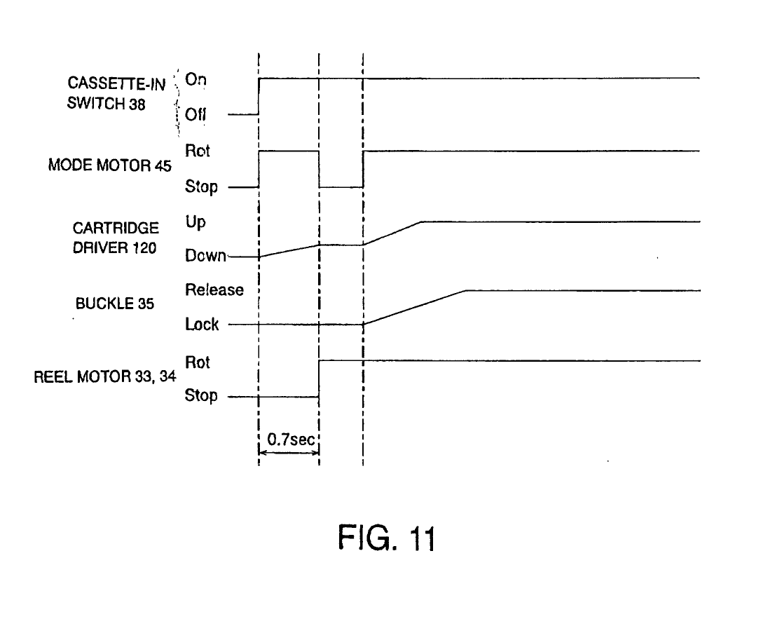

Hereinbelow, referring to FIG. 11, description will be made of an operation of an existing mechanism for removing a sag from a leader tape. In FIG. 11, a top (first) line represents the state of the cassette-in switch 38. A second line represents the rotation state of the mode motor 45. A third line represents the elevation state of the cartridge driver (reel driver) 120. A fourth line represents the state of the buckle 35. A fifth line represents the rotation state of the take-up reel motor 33 and the supply reel motor 34.

When the tape cartridge is loaded in the tape drive 30, the cassette-in switch 38 is turned from an off state (FIG. 6B) into an on state (FIG. 6C) (see the first line in FIG. 11). In response to turning-on of the cassette-in switch 38, a control unit, which is not illustrated in the figure, makes the mode motor 45 rotate for 0.7 second (see the second line in FIG. 11). In response to the rotation of the mode motor 45, the cam gear (ring cam) 140 is rotated so that the cartridge driver (reel driver) 120 is slightly lifted up. At this time, the engaging portion of the buckle 35 is not engaged with the cam portion of the cam gear 140 and the finger-like protrusion 351 of the buckle 35 is fitted into the positioning hole 13 of the take-up leader tape 10. By a buckle arm which is not illustrated in the figure, the tab (FIG. 1) of the take-up leader tape 10 is engaged with the locking hole 21 (FIG. 2) of the supply leader tape 20 to bring the end portion of the take-up leader tape 10 in engagement with the supply leader tape 20.

On the other hand, in order to remove a sag from the supply leader tape 20, the control unit stops the rotation of the mode motor 45 after lapse of 0.7 second after the cassette-in switch 38 is turned on and, simultaneously, rotatably drives the take-up reel motor 33 at a high torque and the supply reel motor 34 at a low torque in a clockwise direction (see the second line and the fifth line in FIG. 11). In other words, back tension is applied to the tape. As a consequence, a sag is removed from the supply leader tape 20.

In this state, the control unit stops the mode motor 45 for a predetermined time interval and thereafter rotates the mode motor 45 again (see the second line in FIG. 11). Following the rotation of the mode motor 45, the cartridge driver (reel driver) 120 is lifted up. Simultaneously, the engaging portion of the buckle 35 is engaged with the cam portion of the cam gear (ring cam) 140 to rotate (drive) the buckle 35 clockwise (see the fourth line in FIG. 11). In this event, the supply reel has a torque weaker than that of the take-up reel 31, so that the supply leader tape 20 (FIG. 2) is pulled out from the tape cartridge.

However, the above-described mechanism for removing a sag from the leader tape has a problem which will be described in the following.

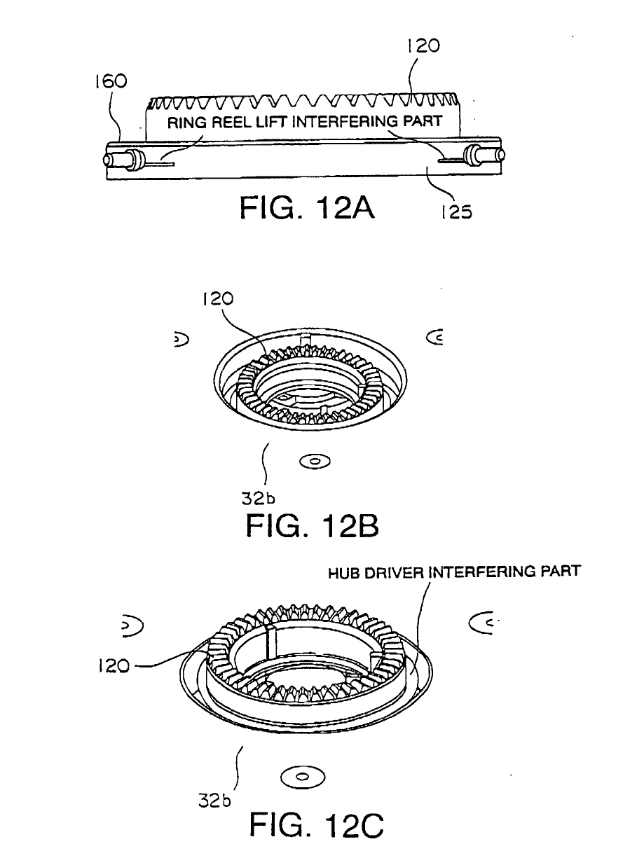

FIGS. 12A to 12C show the reel driver (drive gear, cartridge driver) 120. FIGS. 12A and 12B show the state of the reel driver 120 when the tape cartridge is ejected. These views correspond to FIG. 9. FIG. 12C shows the state of the reel driver 120 in a reel-up condition. This view corresponds to FIG. 10.

Upon ejection (FIGS. 12A, 12B and 9), the reel driver 120 is restricted in its height direction by the ring reel lift (drive ring) 160.

As described above, the take-up reel motor 33 and the supply reel motor 34 start the rotation after lapse of 0.7 second after the cassette-in switch 38 is turned on. In this state, the ring reel lift (drive ring) 160 is lifted up but still interferes with the reel driver (drive gear) 120. In other words, the hook portion 162 of the ring reel lift 160 is in mutual engagement with the outer annular flange 125 of the reel driver 120. Consequently, the supply leader tape 20 is pulled out from the tape cartridge in the above-mentioned interfering condition so that the outer annular flange 125 of the reel driver 120 performs frictional movement with respect to the hook portion 162 of the ring reel lift 160.

In the reel-up condition (FIGS. 12C and 10), the reel driver (drive gear) 120 is restricted in its height by the hub driver (drive hub) 110. In this state, the hook portion 162 of the ring reel lift (drive ring) 160 is located at a position over (that is, at a distance from) the outer annular flange 125 of the reel driver 120 by the operation of the cam gear (ring cam) 140, as illustrated in FIG. 10. Consequently, the above-mentioned frictional movement does not occur even if the reel driver 120 is rotated in this state.

However, the reel driver 120 is made of resin as described above. When loading/ejecting are repeated, the reel driver 120 is worn out due to the above-mentioned frictional movement, as mentioned in the preamble of the present specification. As a result, the upper end of the reel driver 120 may become higher than the upper surface 32U of the gear chassis 32 upon ejection so that the tape cartridge cannot be inserted in the slot 32b of the tape drive 30.

As indicated in the fifth line of FIG. 11, the timing of rotating the take-up reel motor 33 and the supply reel motor 34 is determined by time control. This means that the take-up reel motor 33 and the supply reel motor 34 are rotated at different points depending upon an increase or a decrease in load upon the mechanism (tape drive) 30. This may result in malfunction, for example, the failure in mutual engagement of the reel driver (cartridge driver) 120 and the spindle (reel hub) of the tape cartridge or unsuccessful chucking of the leader tapes 10 and 20, as mentioned in the preamble of the present specification.

Hereinbelow, description will be made in detail about one embodiment of the present invention.

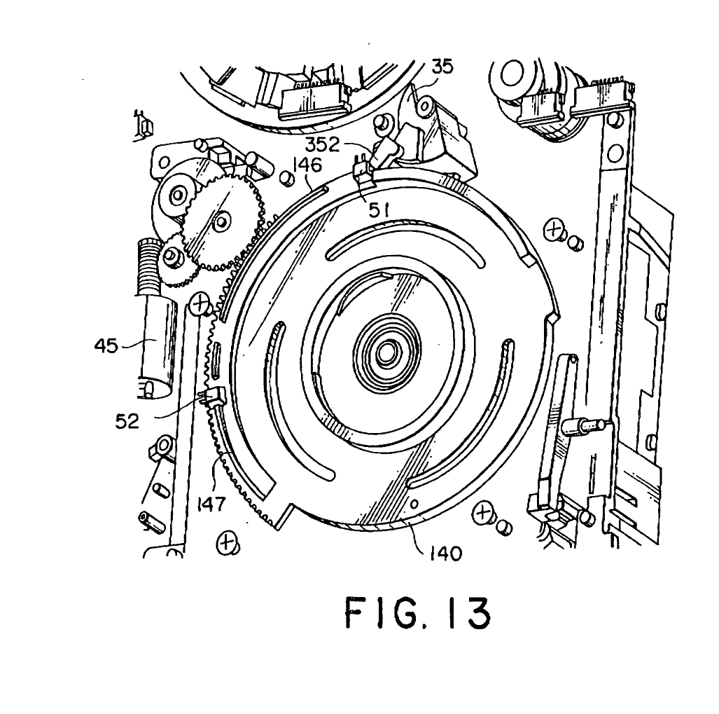

A magnetic tape drive according to this invention is similar to an existing magnetic tape drive except a sag preventing mechanism and its control system for removing sag from the leader tape. Therefore, an embodiment of this invention with respect to portions different from a tape drive shown in FIGS. 1-12 are shown in FIGS. 13-18B and described below. The similar portions are shown by the same reference numerals and are not described in detail.

Referring to FIG. 13, a sag preventing mechanism for removing sag from the leader tape according to this invention comprises a cam gear (ring cam) 140 and a first and a second optical sensor (photo interrupter) 51 and 52 for detecting the rotating angular position of the cam gear (ring cam) 140. The first and the second optical sensors 51 and 52 are mounted on the motor board 61 of the supply reel motor 34.

The ring cam 140 is different from the existing ring cam 140 shown in FIGS. 7, 9 and 10 and has a back surface (a surface of a paper on which FIG. 13 is drawn) provided with first and second arc-shaped shielding plates 146 and 147 for controlling on/off (open/close) of the first and the second optical sensors 51 and 52, respectively. These first and second arc-shaped shielding plates 146 and 147 are formed at angular positions on the same circular about the rotating axis of the ring cam 140.

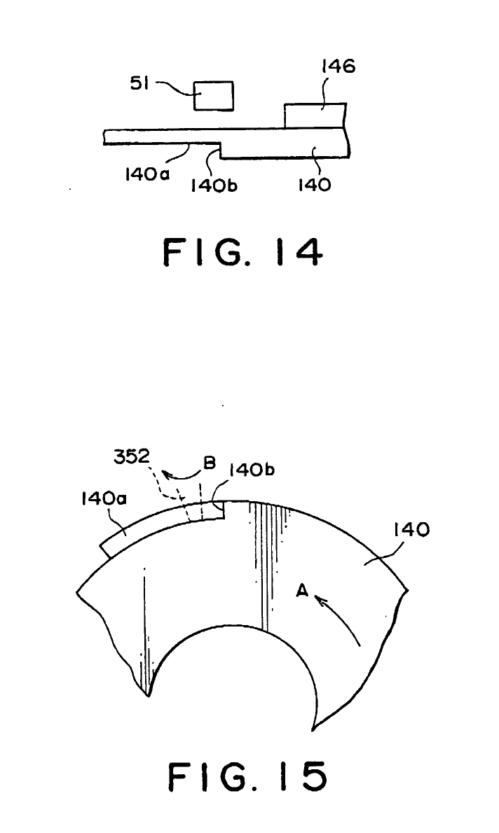

Referring to FIGS. 14 and 15, a ring cam (drive gear) 140 is formed with a cam plane on its surface (an opposite surface of the back surface described above) at its peripheral edge portion. The cam plane comprises a flat surface portion 140a onto which the engaging portion 352 of the buckle 35 slidably rides when the tape cartridge is not loaded in the slots (32b in FIG. 3) of the tape drive, and a cam portion or a step 140b, which engages with the engaging portion 352 of the buckle 35 when the ring cam 140 is rotated by the mode motor 45. Further rotation (in a direction shown by arrow A in FIG. 15) of the ring cam 140 by the mode motor 45 makes buckle 35 in the clockwise direction (in a direction shown by arrow B in FIG. 15) because of engagement of the engaging portion 352 and cam portion 140b.

As described hereinafter, the first optical sensor 51 serves to detect the state where the cartridge driver (reel driver) 120 is completely lifted up. The second optical sensor 52 serves to detect that the buckle 35 is put into a released state. Accordingly, the first and second arc-shaped shielding plates 146 and 147, the first and second optical sensors 51 and 52, and the cam portion 140b have the positional relationship so as to fulfill the above-described angular positions and to achieve the operation described hereinafter.

As described above, the existing control unit performs the time control of the mode motor and real motors so as to remove sag from the leader tape. On the other hand, according to the present invention a control unit does not perform the time control but performs control of those motors with reference to position detection signals from the first and the second optical sensors 51 and 52, as will later be described.

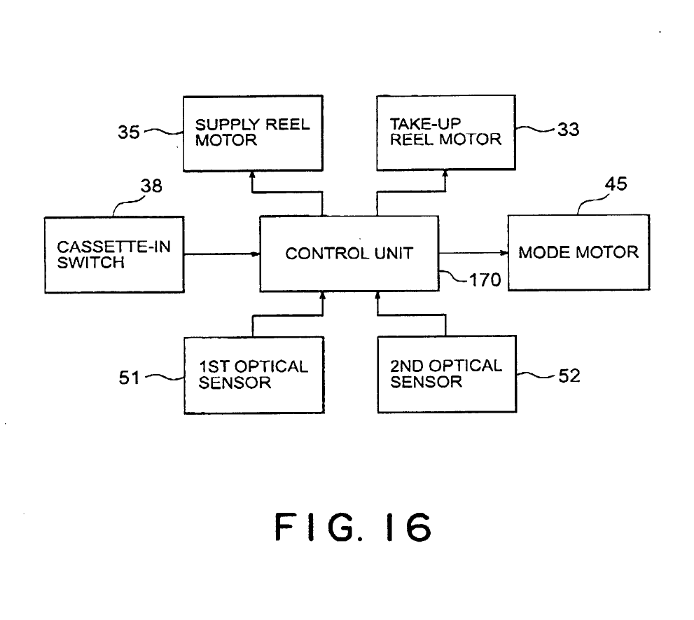

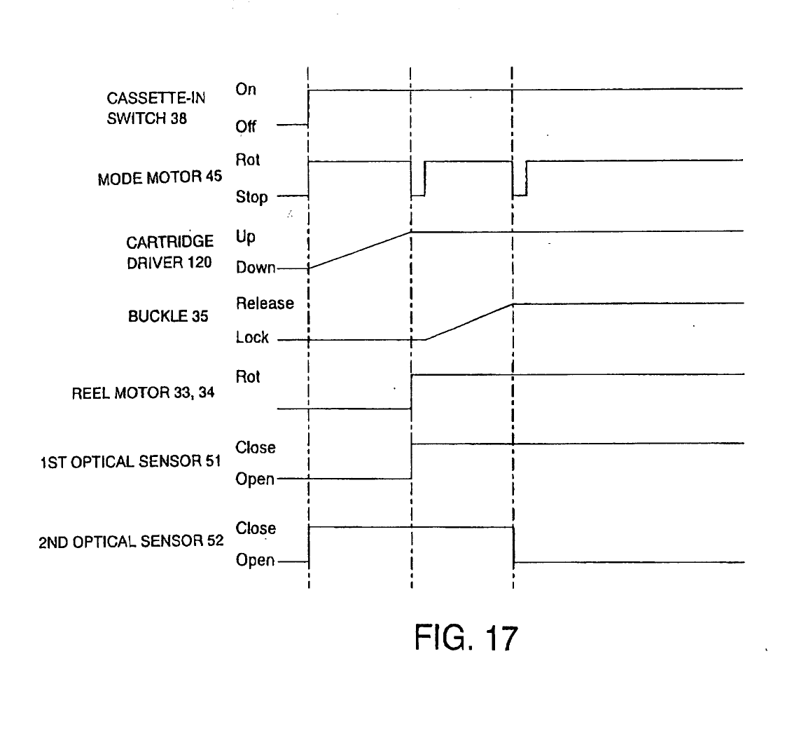

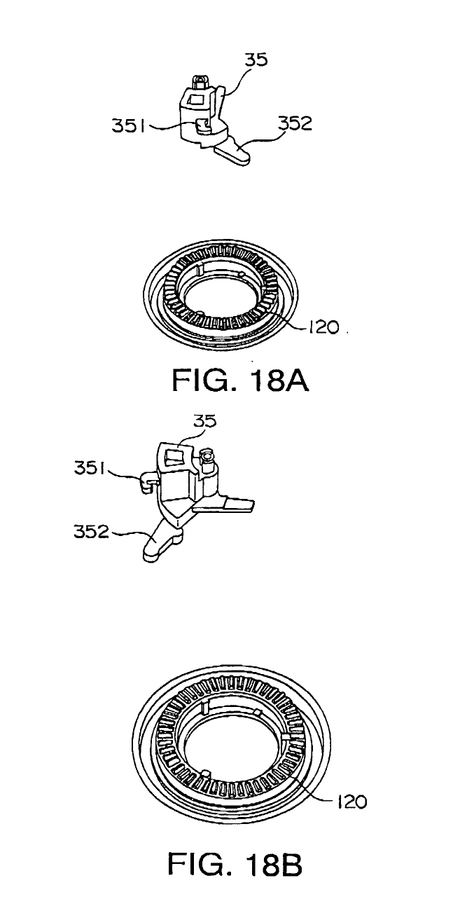

Referring to FIG. 16, a control system, for controlling the sag preventing mechanism for removing sag from the leader tape, comprises a cassette—in switch 38, first and second optical switches 51 and 52, and the control unit 170 connected with these switches. The control unit 170 controls operation of the take-up reel motor 33, supply reel motor 35 and mode motor 45 in response to signals from those switches 38, 51 and 52. The control operation of the control unit 170 will clearly be explained from the description referring to FIGS. 17, 18A and 18B.

FIG. 17 is a timing chart for describing the operation of the sag preventing mechanism for removing a sag from a leader tape according to this embodiment. FIGS. 18A and 18B are views showing a positional relationship of the buckle for describing the operation of the sag preventing mechanism.

In FIG. 17, a top (first) line represents the state of the cassette-in switch 38. A second line represents the rotation state of the mode motor 45. A third line represents an up/down state of the cartridge driver (reel driver) 120. A fourth line represents the state of the buckle 35. A fifth line represents the rotation state of the supply reel motor 34 and the take-up reel motor 33. A sixth line represents an open/close (on/off) state of the first optical sensor 51. A seventh line represents an open/close (on/off) state of the second optical sensor 52.

FIG. 18A shows the state of the cartridge driver (reel driver) 120 after put into the reel-up condition. FIG. 18B shows the state after the buckle 35 is operated.

When the tape cartridge is not loaded in but ejected form the tape drive 30, the cassette-in switch 38 is in the off state (FIG. 6B and the first line in FIG. 17). At this time, the first optical sensor 51 and the second optical sensor 52 are in the open state (on state) (see the sixth line and the seventh line in FIG. 17). The reel motors 33 and 35, and the mode motor 45 are in the stop condition. The cartridge driver 120 is in a lowered condition (see third line in FIG. 17) and the buckle 35 is in a stop condition (fourth line in FIG. 17) under engaging the take-up leader tape.

When the tape cartridge is loaded in the tape drive 30, the cassette-in switch 38 is turned from the off state (FIG. 6B) into the on state (FIG. 6C) (see the first line in FIG. 17). At this time, the first optical sensor 51 is in the opened state (on state) while the second optical sensor 52 is in the closed state (off state) (see the sixth line and the seventh line in FIG. 17).

In response to turning-on of the cassette-in switch 38, the control unit 170 makes the mode motor 45 rotate (see the second line in FIG. 17). In response to the rotation of the mode motor 45, the cam gear (ring cam) 140 is rotated so that the cartridge driver 120 is continuously lifted up. At this time, an engaging portion 352 of the buckle 35 is not engaged with a cam portion of the cam gear 140, and a finger-like protrusion 351 of the buckle 35 is fitted into the positioning hole 13 (FIG. 1) of the take-up leader tape 10. By a buckle arm, which is not illustrated in the figure, a tab 12 (FIG. 1) of the take-up leader tape 10 is engaged with a locking hole 21 (FIG. 2) of the supply leader tape 20 to bring an end portion of the take-up leader tape 10 in engagement with the supply leader tape 20.

By continuous rotation of the mode motor 45, the cartridge driver 120 is completely lifted up (see FIG. 18A). The control unit 170 detects this time instant by transition of the first optical sensor 51 from the opened state (on state) into the closed state (off state) (see the sixth line in FIG. 18). In response to the detection signal from the first optical sensor 51, the control unit 170 stops driving the mode motor 45 for a short time interval and then rotates it again. Simultaneously, the supply reel motor 34 and the take-up reel motor 33 are rotatably driven at a low torque and a high torque, respectively, in a clockwise direction (see the fifth line in FIG. 17). Thus, the tape is applied with back tension. As a consequence, the sag of the supply leader tape 20 is removed.

At this time instant, as shown in FIGS. 18A, 12C and 10, the cartridge driver (reel driver) 120 is put into a complete reel-up condition. Thus, even if the supply reel motor 34 and the take-up reel motor 33 are rotatably driven, the ring reel lift (drive ring) 160 does not interfere with the reel driver (drive gear) 120. In other words, an unengageable relationship (state) is established between the hook portion 162 of the ring reel lift 160 and the outer annular flange 125 of the reel driver 120. In such a noninterfering state, the supply leader tape 20 is pulled out from the tape cartridge. Therefore, the outer annular flange 125 of the reel driver 120 does not make frictional movement with respect to the hook portion 162 of the ring reel lift 160.

Thereafter, by the rotation of the mode motor 45, the engaging portion 352 of the buckle 35 is engaged with the cam portion of the cam gear 140 so that the buckle 35 is rotated (driven) clockwise (see the fourth line in FIG. 17). Then, by the continuous rotation of the mode motor 45, the buckle 35 is put into a released state. The control unit 170 detects this time instant by transition of the second optical sensor 52 from the closed state (off state) into the opened state (on state) (see the seventh line in FIG. 17). This state is shown in FIG. 18B.

As described above, in the present invention, use is made of a mechanism in which the operation of the reel driver (cartridge driver) 120 is separated from the operation of the buckle 35 (that is, a mechanism in which the buckle 35 is operated after the reel driver 120 is completely lifted up). Further, the ring cam 140 is provided with the first and second shielding plates 146 and 147 on a same circles about the rotating axis of the ring cam 140 and the first and the second optical sensors 51 and 52 are provided to detect each operating position. With this structure, the supply reel motor 34 can be rotated without the interference between the reel driver 120 and the ring reel lift 160. As a result, the position of the reel driver 120 upon ejection does not change. Further, the supply reel motor 34 is not applied with a load so that the life thereof is improved. Moreover, since each operating position is detected by the optical sensors 51 and 52, it is possible to get rid of malfunction due to load fluctuation in the mechanism (tape drive) 30. Thus, it is possible to prevent the failure in engagement of the reel driver (cartridge driver) 120 and the spindle (reel hub) of the tape cartridge and the unsuccessful chucking of the leader tapes 10 and 20.

Further, because the first and second shielding plates 146 and 147 are formed at the peripheral edge on the surface of the ring cam 140 and at different angular positions along a circle about the rotation axis of the ring cam 140, while the first and the second optical sensors 51 and 52 being disposed to straddle the first and second shielding plates 146 and 147, respectively, it is possible to avoid the ring cam 140 from increase of its size.

Although the present invention has been described so far in conjunction with the preferred embodiment, it will readily be understood that the present invention is not restricted to the above-mentioned embodiment.

As is obvious from the foregoing description, in the present invention, the buckle is operated after the reel driver is completely lifted up. Therefore, it is possible to prevent the reel driver from being worn out even if loading/ejecting are repeated. Further, inasmuch as each operating position is detected by the optical sensors, it is possible to prevent malfunction due to load fluctuation in the mechanism.

What is claimed is:

1. A magnetic tape drive for driving a magnetic tape contained in a tape cassette loaded thereinto, said magnetic tape being wound on a supply reel within said tape cassette and having a supply leader tape at a leading end thereof, which comprises:
a take-up reel with a take-up leader tape;
a take-up reel motor for rotating said take-up reel;
a cassette-in switch for detecting said tape cassette loaded in said tape drive to produce a cassette-in signal;
a mode motor;
a ring cam having a cam rotating axis and rotated about said cam rotating axis by said mode motor, said ring cam having a first and a second arc-shaped shielding plates formed at different angular positions on a circle around said cam rotating axis;
a first and a second optical sensors fixedly disposed so as to straddle said first and said second arc-shaped shielding plates, respectively, when said ring cam is rotated, said first and second optical sensors producing first and second detection signals, respectively, depending on a rotation angular position of said ring cam;
a supply reel motor;
a reel driver having a rotary axis and rotated about said rotary axis by said supply reel motor, said reel driver operatively coupled with said ring cam to move along its rotary axis to engage with and rotate said supply reel in said tape cassette loaded;
a buckle supporting said take-up leader tape and operatively coupled with said ring cam to transfer said take-up leader tape to said supply leader tape to connect between said take-up leader tape and said supply leader tape; and
a control unit connected with said cassette switch, said first and second optical switches, said take-up reel motor, said mode motor, and said supply reel motor, said control unit controlling rotation of said take-up reel motor, said mode motor, and said supply reel motor in response to said cassette-in signal, said first detection signal, and said second detection signal.

2. A magnetic tape drive claimed in claim 1, wherein said control unit is actuated by said cassette-in signal to rotate said mode motor, then rotates said supply reel motor and said take-up reel motor and simultaneously stops rotation of said mode motor to make a temporal stop period when receiving said first detection signal after receiving said second detection signal, then again rotates said mode motor after said temporal strop period, and thereafter stops said mode motor when said second detection signal is stopped.

3. A magnetic tape drive claimed in claim 2, wherein said reel driver and said ring cam are operatively coupled so that said reel driver being moved by rotation of said ring cam due to the rotation of said mode motor to engage with said supply reel before said control unit receives said first detection signal.

4. A magnetic tape drive claimed in claim 2, wherein said buckle is operatively coupled with said ring cam so that said buckle is actuated by rotation of said ring cam to make said take-up leader tape engage with said supply leader tape before said control unit receives said first detection signal, and said buckle thereafter releases and transfers said take-up leader tape to said supply leader tape depending on said rotation of said supply reel motor and said take-up reel motor before said first detection signal stops.

5. A magnetic tape drive claimed in claim 4, wherein said supply leader tape is pulled by said take-up leader tape to remove sag of said supply leader tape by said rotation of said supply reel motor and said take-up reel motor during said temporal stop period.
